(19) United States
(12) Patent Application Publication
(10) Pub. No.: US 2020/0012714 A1
(43) Pub. Date: Jan. 9, 2020

(54) Contextual Graphical User Interface Forms

(71) Applicant: SAP SE, Walldorf (DE)

(72) Inventors: Cody Anhorn, Minneapolis, MN (US); Matthew Braton, Minneapolis, MN (US); Christopher Nickel-Felton, Minneapolis, MN (US)

(21) Appl. No.: 16/026,666

(22) Filed: Jul. 3, 2018

(51) Int. Cl. G06F 17/24; G06F 17/30; G06F 3/048

(52) U.S. Cl. CPC G06F 17/243; G06F 3/048; G06F 17/3089; G06F 17/30876

(57) ABSTRACT

Display of a graphical user interface form is initiated in response to selection of a targeted uniform resource locator (URL) directed to a customer destination. The form can have a plurality of required fields. Thereafter, using identification information for the customer encapsulated within the targeted URL, at least one data source is polled to obtain data associated with the form and the customer. Based on the polling and the obtained data, an identification of which of the plurality of required fields do not have entries in the at least one data source is made. In response, the graphical user interface form is generated and rendered in a graphical user interface so as to include the identified fields and to exclude at least a portion of the other fields. Related apparatus, systems, techniques and articles are also described.

### TECHNICAL FIELD

The subject matter described herein relates to graphical user interface forms that are dynamically created to only include fields requesting missing information.

### BACKGROUND

E-mail campaigns remain an effective way for companies to communicate with large numbers of customers. However, the effectiveness of such campaigns is diminishing given the widespread nature of such e-mails (especially if you consider the number of spam e-mails). In particular, users are increasingly reluctant to spend the time required to enter relevant information that may be requested by such e-mails, whether it be part of a lead-generation campaign or otherwise.

### SUMMARY

In a first aspect, display of a graphical user interface (GUI) form is initiated in response to selection of a targeted uniform resource locator (URL) directed to a customer destination. The form can have a plurality of required fields. Thereafter, using identification information for the customer encapsulated within the targeted URL, at least one data source is polled to obtain data associated with the form and the customer. Based on the polling and the obtained data, an identification of which of the plurality of required fields do not have entries in the at least one data source is made. In response, the graphical user interface form is generated and rendered in a graphical user interface so as to include the identified fields and to exclude at least a portion of the other fields.

The URLs can be transmitted to each of a plurality of customer e-mail addresses in such a fashion that each URL is unique and embedded in an e-mail with other visual content.

The initiating display of the graphical user interface form can include rendering, in a web browser, a landing page.

User-generated input can be received, via the graphical user interface, filling out as least one of the identified field. In response to such input, the at least one data source can be updated to include at least a portion of the user-generated input.

The generated graphical user interface can include one of the other fields and populating such field with information within the obtained data from the at least one data source.

The targeted URL can further encapsulate information identifying a particular campaign. With such information, the graphical user interface form can be selected from a plurality of available graphical user interface forms using the information identifying the particular campaign.

The customer destination can be an e-mail address, a mobile phone application instance, and/or a mobile phone telephone number.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides a graphical user interface with enhanced usability which increases the likelihood of a user successfully completing the form once initiating the process.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating claim 1; AND

FIG. 2 is a diagram illustrating a sample campaign e-mail with alternative graphical user interface forms.

FIG. 3 is a process flow diagram for providing a contextual graphical user interface form; and

FIG. 4 is a diagram illustrating a computing device for implementing aspects described herein.

### DETAILED DESCRIPTION

The current subject matter is directed to advanced graphical user interfaces in which forms are dynamically rendered such that fields with missing information are included. In addition, with some variations, fields with pre-existing information can be populated within the forms rendered within such graphical user interfaces.

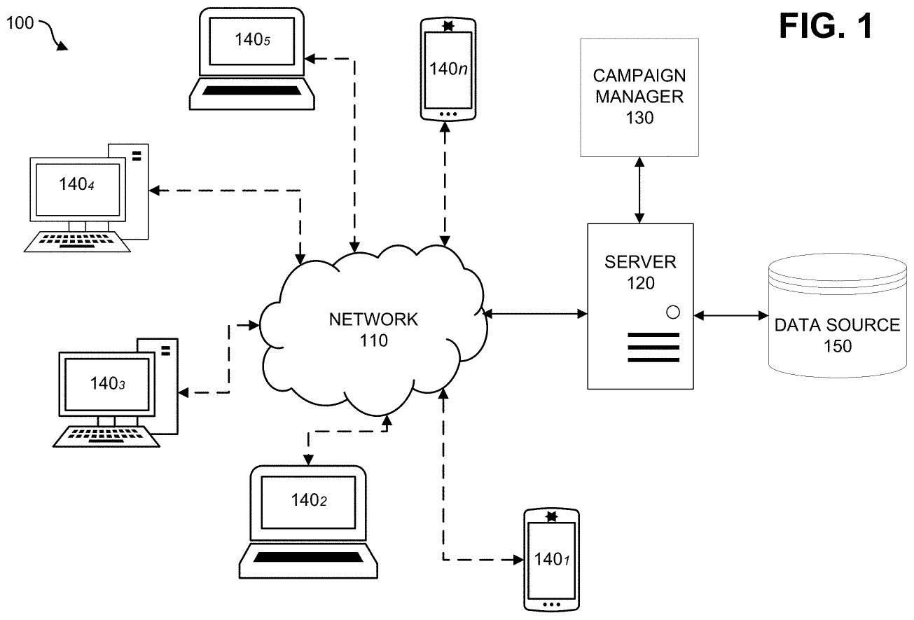

FIG. 1 is a diagram 100 of a computing environment for implementing the subject matter described herein. A campaign manager 130 (which can comprise one or more computing devices) is in direct or indirect communication with a server 120. The campaign manager 130 can, for example, initiate the transmission of e-mail campaigns via the server 120 over a network 110 (or series of networks) to each of a plurality of computing nodes 140_{1 . . . n} (corresponding to computing devices at which users access their e-mail or applications).

An e-mail campaign, as that term is used herein, can comprise an e-mail or other communication (for example, an SMS message, an MMS message, a mobile phone application notification or view, etc.) in which a portion of the content is uniform for all of the recipients (e.g., customers, clients, potential clients, etc.) while at least a portion is unique or otherwise tailored for the particular user. The content specific to the recipient can be a targeted URL.

In some cases, the targeted URL can be a one-time use URL in that it includes a one-time key which, can only be utilized once (i.e., the campaign manager 130 will only allow the corresponding form to be rendered a single time). If the URL is attempted to be used a second time, a notice can be conveyed to the user stating that the URL/link is no longer active, a default form can be presented, and/or other information can be conveyed as may be desired.

The targeted URL can also include information identifying a particular campaign (so that a corresponding form can be rendered) and information sufficient to identify the recipient. Such information can be hashed or otherwise encoded. When a particular campaign email is being generated for a recipient, the system can parse links that match a landing page pattern for the company the user contained in. When the link matches a landing page pattern, the system can take the information of the recipient, the campaign, and the company, encodes such information and append the encoded information the URL. The URL can also have a one-time key generated for the landing page URL and appended.

When a user at one of the recipient computing nodes 140_{1 . . . n} activates the respective targeted URL, the server 120 is accessed via the network 120 which causes the graphical user interface to ultimately render a form with fields (unless the URL is no longer active). In cases in which the campaign information is embedded within the targeted URL, the campaign manager 130 can identify which of a plurality of template forms to use (i.e., the campaign manager 130 selects the form associated with the particular campaign). The identified GUI form can include a plurality of possible fields.

Thereafter, the campaign manager 130 and/or the server 120 can poll a data source 150 (it will be appreciated that there may multiple data sources) using the customer identification (after being parsed from the targeted URL) to obtain information relevant to the customer (i.e., the e-mail recipient). In some cases, the polling simply returns information identifying which fields have null or zero values (thus identifying such fields as missing needed information). In other cases, an entire record for the customer can be returned so that a determination can be made, either by the server 120 or the campaign manager 130, which fields of the corresponding form require values from the customer/user.

The form can be rendered in the graphical user interface once it is determined which fields require user-input (i.e., the incomplete fields). The server 120 causes, on the electronic visual display at the corresponding node 1201 . . . n, the form to be rendered with some or all of the incomplete fields. The server 120 can cause some or all of the user-generated input received via such rendered form to be saved in the data source 150 (i.e., values in the record for the customer can be updated with the information input into the fields).

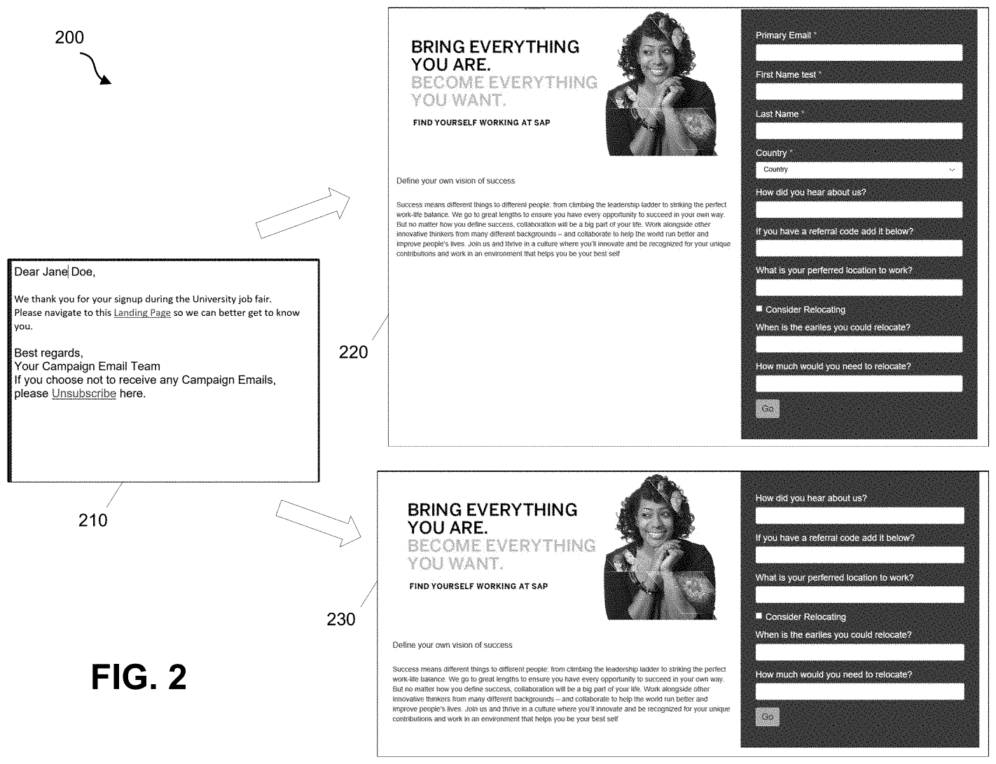

FIG. 2 is a diagram 200 illustrating an arrangement including a sample campaign message 210. The campaign message 210 can include an embedded URL (i.e., link corresponding to “Landing Page”) which, when activated, causes a data source (not shown to be polled) to determine which information associated with the recipient of the campaign message is needed for a particular recipient of the message. In a first scenario, the data source (or potentially the URL) indicates that there is no information available for the user, and as such, a graphical user interface form 220 includes fields requesting basic information such as e-mail address, first name, last name, and country. In a second scenario, the data source indicates that certain information is already available for the recipient of the campaign message (i.e., e-mail address, first name, last name, country) and, as such, a corresponding graphical user interface form 230 omits fields corresponding to that certain information. Such an arrangement is advantageous in that provides for a simplified view that increases a likelihood of obtaining prompted information from the recipient.

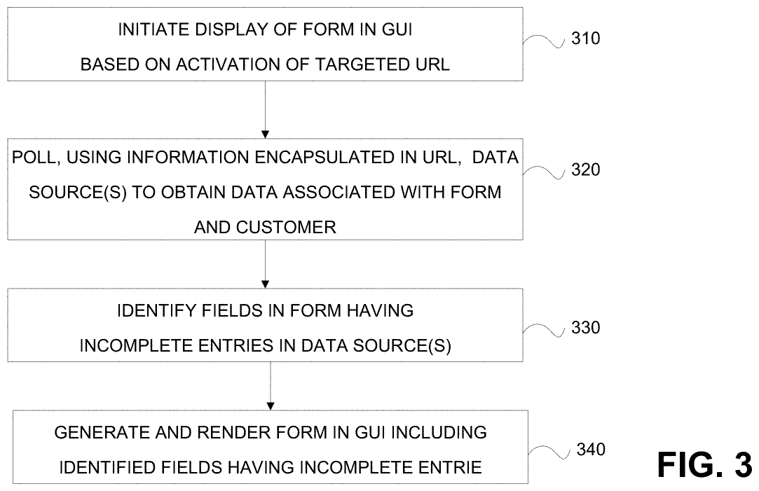

FIG. 3 is a process flow diagram 300 in which, at 310, in response to selection of a targeted URL directed to a customer destination, display of a graphical user interface form having a plurality of required fields is initiated. Thereafter, at 320, using identification information for the customer encapsulated within the targeted URL, at least one data source is polled to obtain data associated with the form. Based on the polling and the obtained data, at 330, fields are identified that do not have entries in the at least one data source (i.e., a determination is made as to which information about the customer is missing, etc.). Subsequently, at 340, the graphical user interface form is generated and rendered so as to include the identified fields and to exclude at least a portion of the other fields.

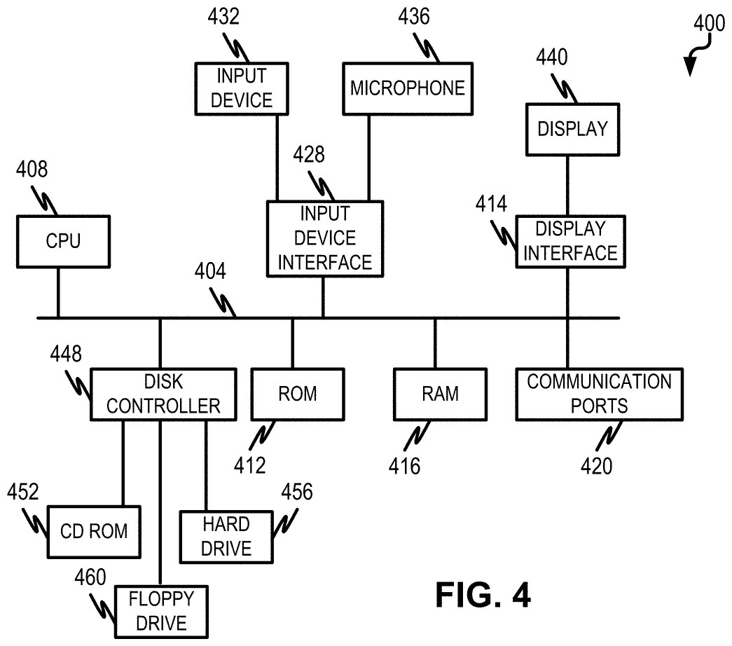

FIG. 4 is a diagram 400 illustrating a sample computing device architecture for implementing various aspects described herein. A bus 404 can serve as the information highway interconnecting the other illustrated components of the hardware. A processing system 408 labeled CPU (central processing unit) (e.g., one or more computer processors/data processors at a given computer or at multiple computers), can perform calculations and logic operations required to execute a program. A non-transitory processor-readable storage medium, such as read only memory (ROM) 412 and random access memory (RAM) 416, can be in communication with the processing system 408 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 448 can interface one or more optional disk drives to the system bus 404. These disk drives can be external or internal floppy disk drives such as 460, external or internal CD-ROM, CD-R, CD-RW or DVD, or solid state drives such as 452, or external or internal hard drives 456. As indicated previously, these various disk drives 452, 456, 460 and disk controllers are optional devices. The system bus 404 can also include at least one communication port 420 to allow for communication with external devices either physically connected to the computing system or available externally through a wired or wireless network. In some cases, the communication port 420 includes or otherwise comprises a network interface.

To provide for interaction with a user, the subject matter described herein can be implemented on a computing device having a display device 440 (e.g., a CRT (cathode ray tube) or LCD (liquid crystal display) monitor) for displaying information obtained from the bus 404 to the user and an input device 432 such as keyboard and/or a pointing device (e.g., a mouse or a trackball) and/or a touchscreen by which the user can provide input to the computer. Other kinds of input devices 432 can be used to provide for interaction with a user as well; for example, feedback provided to the user can be any form of sensory feedback (e.g., visual feedback, auditory feedback by way of a microphone 436, or tactile feedback); and input from the user can be received in any form, including acoustic, speech, or tactile input. In the input device 432 and the microphone 436 can be coupled to and convey information via the bus 404 by way of an input device interface 428. Other computing devices, such as dedicated servers, can omit one or more of the display 440 and display interface 414, the input device 432, the microphone 436, and input device interface 428.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) and/or a touch screen by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer implemented method comprising:
initiating, in response to selection of a targeted uniform resource locator (URL) directed to a customer destination, display of a graphical user interface form having a plurality of required fields;
polling, using identification information for the customer encapsulated within the targeted URL, at least one data source to obtain data associated with the form and the customer;
identifying, based on the polling and the obtained data, which of the plurality of required fields do not have entries in the at least one data source; and
generating and rendering the graphical user interface form in a graphical user interface to include the identified fields and to exclude at least a portion of the other fields.

2. The method of claim 1 further comprising:
transmitting the URLs to each of a plurality of customer e-mail addresses, wherein each URL is unique and embedded in an e-mail with other visual content.

3. The method of claim 1, wherein the initiating display of the graphical user interface form comprises rendering, in a web browser, a landing page.

4. The method of claim 1 further comprising:
receiving user-generated input, via the graphical user interface, filling out as least one of the identified field.

5. The method of claim 4 further comprising:
updating the at least one data source to include at least a portion of the user-generated input.

6. The method of claim 1 further comprising:
causing the generated graphical user interface form to include one of the other fields and populating such field with information within the obtained data from the at least one data source.

7. The method of claim 1, wherein the targeted URL further encapsulates information identifying a particular campaign and the method further comprises:
selecting the graphical user interface form from a plurality of available graphical user interface forms using the information identifying the particular campaign.

8. The method of claim 1, wherein the customer destination is an e-mail address.

9. The method of claim 1, wherein the customer destination is a mobile phone application instance.

10. The method of claim 1, wherein the customer destination is a mobile phone telephone number.

11. A system comprising:
at least one data processor; and
memory storing instructions which, when executed by the at least one data processor, result in operations comprising:
initiating, in response to selection of a targeted uniform resource locator (URL) directed to a customer destination, display of a graphical user interface form having a plurality of required fields;
polling, using identification information for the customer encapsulated within the targeted URL, at least one data source to obtain data associated with the form and the customer;
identifying, based on the polling and the obtained data, which of the plurality of required fields do not have entries in the at least one data source; and
generating and rendering the graphical user interface form in a graphical user interface to include the identified fields and to exclude at least a portion of the other fields.

12. The system of claim 11, wherein the operations further comprise:
transmitting the URLs to each of a plurality of customer e-mail addresses, wherein each URL is unique and embedded in an e-mail with other visual content.

13. The system of claim 12, wherein the initiating display of the graphical user interface form comprises rendering, in a web browser, a landing page.

14. The system of claim 11, wherein the operations further comprise:
receiving user-generated input, via the graphical user interface, filling out as least one of the identified field.

15. The system of claim 14, wherein the operations further comprise:
updating the at least one data source to include at least a portion of the user-generated input.

16. The system of claim 11, wherein the operations further comprise:
causing the generated graphical user interface form to include one of the other fields and populating such field with information within the obtained data from the at least one data source.

17. The system of claim 11, wherein the targeted URL further encapsulates information identifying a particular campaign and the operations further comprise:
selecting the graphical user interface form from a plurality of available graphical user interface forms using the information identifying the particular campaign.

18. The system of claim 11, wherein the customer destination is at least one of: an e-mail address, a mobile phone application instance, or a mobile phone telephone number.

19. A non-transitory computer program product storing instructions which, when executed by at least one data processor forming part of at least one computing device, result in operations comprising:
initiating, in response to selection of a targeted uniform resource locator (URL) directed to a customer destination, display of a graphical user interface form having a plurality of required fields;
polling, using identification information for the customer encapsulated within the targeted URL, at least one data source to obtain data associated with the form and the customer;
identifying, based on the polling and the obtained data, which of the plurality of required fields do not have entries in the at least one data source; and
generating and rendering the graphical user interface form in a graphical user interface to include the identified fields and to exclude at least a portion of the other fields.

20. The non-transitory computer program product of claim 19, wherein the customer destination is at least one of: an e-mail
